(19) United States
(12) Patent Application Publication
(10) Pub. No.: US 2019/0107725 A1
(43) Pub. Date: Apr. 11, 2019

(54) DISPLAY DEVICE

(71) Applicant: PIONEER CORPORATION, Bunkyo-ku, Tokyo (JP)

(72) Inventor: Yuji ITO, Kawagoe-shi, Saitama (JP)

(21) Appl. No.: 16/088,612

(22) PCT Filed: Mar. 28, 2016
(86) PCT No.: PCT/JP2016/059897

§ 371 Date: Sep. 26, 2018

(51) Int. Cl. G02B 27/01; G06F 3/14; G02B 27/00; B60K 35/00

(52) U.S. Cl. CPC G02B 27/0179; G06F 3/1446; G02B 27/0093; G02B 27/0101; H04N 9/3135; G02B 2027/014; G02B 2027/0187; G02B 2027/0127; B60K 35/00

(57) ABSTRACT

A display device (1) includes: screens (13a), (13b), (13c), and (13d) that perform display at positions having respectively different distances from an observer; and a video controller (6) that causes the screens (13a), (13b), (13c), and (13d) to display images, respectively. The screens (13a), (13b), (13c), and (13d) perform display in such a manner that a first region that is a part of the screen (13a), from among the screens (13a), (13b), (13c), and (13d), and a second region that is a part of the screen (13b) overlap with each other as seen from the observer. The video controller (6) causes the first region and the second region to display the same partial image.

### TECHNICAL FIELD

The present invention relates to a display device.

### BACKGROUND ART

Patent Literature 1, for example, describes a display device capable of changing a display distance of an image. Patent Literature 1 further describes that a plurality of screens (display units) are disposed at intervals.

A method described in Patent Literature 1 allows depth display to be obtained by causing a plurality of images to be displayed at different depth positions.

### CITATION LIST

### Patent literature

Patent Literature 1: Japanese Patent Application Laid-Open No. 2009-150947

### SUMMARY OF INVENTION

### Technical Problem

In the method shown in Patent Literature 1, however, since the respective screens are disposed at intervals, projection light leaks from between the screens. Thus, an observer may feel glaring or observe a slit, for example, depending on his or her viewpoint. Therefore, no thought has been given to obtaining continuous display over the plurality of screens.

In light of the aforementioned problem, it is an object of the present invention to provide a display device capable of obtaining continuous depth display over a plurality of display units, for example.

### Solution to Problem

In order to solve the above-mentioned problem, an invention described in claim 1 is a display device including: a plurality of display units configured to perform display at positions having respectively different distances from an observer; and a control unit configured to cause the plurality of display units to display images, respectively. The plurality of display units perform display in such a manner that at least a first region that is a part of one display unit of the plurality of display units and a second region that is a part of another display unit disposed adjacent to the one display unit and closer to the observer overlap with each other as seen from the observer. The control unit causes the second region to display an image based on a partial image displayed in the first region.

An invention described in claim 7 is a display method of a display device including a plurality of display units configured to perform display at positions having respectively different distances from an observer, the plurality of display units performing display in such a manner that at least a first region that is a part of one display unit of the plurality of display units and a second region that is a part of another display unit disposed adjacent to the one display unit and closer to the observer overlap with each other as seen from the observer. The method includes a control step of causing the plurality of display units to display images, respectively. The control step includes causing the second region to display an image based on a partial image displayed in the first region.

An invention described in claim 8 is a display program configured to cause a computer to execute the display method described in claim 7.

An invention described in claim 9 is a computer-readable recording medium that stores the display program described in claim 8.

### BRIEF DESCRIPTION OF DRAWINGS

FIG. 1 is a diagram illustrating a general configuration of a display device according to a first embodiment of the present invention.

FIG. 2 is an explanatory diagram for the display of video projected onto a screen shown in FIG. 1.

FIG. 3 is a diagram for explaining how projected projection light projected onto the screen shown in FIG. 1 is seen by an observer.

FIG. 4 is a diagram for explaining a processing method for obtaining continuous display on the screen shown in FIG. 1.

FIG. 5 is a diagram for explaining how video processed by the method explained with FIG. 4 is seen by the observer when displayed on the screen.

FIG. 6 is a diagram illustrating a general configuration of a head-up display including a display device according to a second embodiment of the present invention.

FIG. 7 is a diagram illustrating a general configuration of a display device according to a third embodiment of the present invention.

FIG. 8 is a schematic cross-sectional view of a screen shown in FIG. 7.

FIG. 9 is an explanatory diagram for an exemplary relationship between the screen shown in FIG. 7 and the line of sight.

FIG. 10 is a timing chart for operations of the display device shown in FIG. 7.

FIG. 11 is a diagram illustrating a general configuration of a head-up display including a display device according to a fourth embodiment of the present invention.

FIG. 12 is an explanatory diagram for adjustment of overlapping periods in a video controller shown in FIG. 11.

FIG. 13 is an explanatory diagram for adjustment of overlapping periods in the video controller shown in FIG. 11.

FIG. 14 is an explanatory diagram for adjustment of overlapping periods in the video controller shown in FIG. 11.

FIG. 15 is a diagram illustrating a general configuration of a head-up display including a display device according to another embodiment of the present invention.

FIG. 16 is a timing chart for operations of the display device shown in FIG. 15.

FIG. 17 is a diagram illustrating a general configuration of a head-up display including a display device according to another embodiment of the present invention.

FIG. 18 is a timing chart for operations of the display device shown in FIG. 17.

FIG. 19 is a diagram illustrating a general configuration of an amusement machine including a display device according to another embodiment of the present invention.

FIG. 20 shows a display example of the amusement machine shown in FIG. 19.

FIG. 21 is a diagram for explaining another screen configuration.

FIG. 22 is an explanatory diagram for a display example shown in FIG. 22.

### DESCRIPTION OF EMBODIMENTS

A display device according to one embodiment of the present invention will be described below. The display device according to one embodiment of the present invention includes: a plurality of display units that perform display at positions having respectively different distances from an observer; and a control unit that causes the plurality of display units to display images, respectively. The plurality of display units perform display in such a manner that at least a first region that is a part of one display unit of the plurality of display units and a second region that is a part of another display unit disposed adjacent to the one display unit and closer to the observer overlap with each other as seen from the observer. The control unit causes the second region to display an image based on a partial image displayed in the first region. Since display is performed in such a manner that at least parts of the display units overlap with each other as just described, light leakage, for example, can be reduced as much as possible. Moreover, in the portion where the one display unit and the another display unit overlap with each other, an image based on the partial image displayed in the first region (e.g., the same content) is displayed also on the another display unit disposed on the near side thereof. Thus, partial image missing in the overlapping portion can be prevented from occurring.

The plurality of display units can be switched between a transmission state in which light is transmitted and a scattering state in which the light is scattered. The control unit may control a switching period between the scattering state and the transmission state in the one display unit and a switching period between the transmission state and the scattering state in the another display unit to be a period during which the partial image is displayed. In this manner, the transmission state transitions to the scattering state during the period in which the image based on the partial image displayed in the first region is displayed in the two overlapping regions. Thus, influence on display due to the switching of displayed parts can be diminished.

The control unit may set a display period of an image corresponding to a part of the partial image displayed in the first region that cannot be visually recognized by the observer to be the switching period between the scattering state and the transmission state. This allows for display switching to another display unit in the part that cannot be visually recognized by the observer due to the overlapping of the display units. Thus, light leakage, for example, can be reduced at the time of switching.

A temperature detection unit configured to detect an ambient temperature of the display units may be further included, and the control unit may change ranges of the first region and the second region on the basis of a detection result of the temperature detection unit. In this manner, it is possible to cope with change in switching period to the scattering state, for example, due to temperature. Thus, even when the ambient temperature of the display units varies, partial image missing or light leakage, for example, can be prevented from occurring.

An eye-gaze detection unit configured to detect the line of sight of the observer may be further included, and the control unit may change ranges of the first region and the second region on the basis of a detection result of the eye-gaze detection unit. In this manner, the ranges of the first region and the second region can be adjusted according to the position of the observer to achieve continuous display.

Three or more such display units may be included. The control unit may control at least two adjacent display units of the plurality of display units so as to display the image based on the partial image displayed in the first region in the second region and control the remaining display unit so as not to display the image based on the partial image displayed in the first region. In this manner, continuous depth display and planar display can be mixed.

A display method according to one embodiment of the present invention is a display method of a display device including a plurality of display units that perform display at positions having respectively different distances from an observer, the plurality of display units performing display in such a manner that at least a first region that is a part of one display unit of the plurality of display units and a second region that is a part of another display unit disposed adjacent to the one display unit and closer to the observer overlap with each other as seen from the observer. The method includes a control step of causing the plurality of display units to display images, respectively. The control step includes causing the second region to display an image based on a partial image displayed in the first region. Since display is performed in such a manner that at least parts of the display units overlap with each other as just described, light leakage, for example, can be reduced as much as possible. Moreover, in the portion where the one display unit and the another display unit overlap with each other, an image based on the partial image displayed in the first region (e.g., the same content) is displayed also on the another display unit disposed on the near side thereof. Thus, partial image missing in the overlapping portion can be prevented from occurring.

A display program that causes a computer to execute the above-described display method may be provided. Consequently, with the use of the computer, an image based on the partial image displayed in the first region (e.g., the same content) is displayed also on the another display unit disposed on the near side thereof in the portion where the one display unit and the another display unit overlap with each other. Thus, partial image missing in the overlapping portion can be prevented from occurring.

The above-described display program may be stored in a computer-readable recording medium. Consequently, the program can be distributed by itself instead of installing the program in a device, and version update thereof, for example, can be easily done.

### First Embodiment

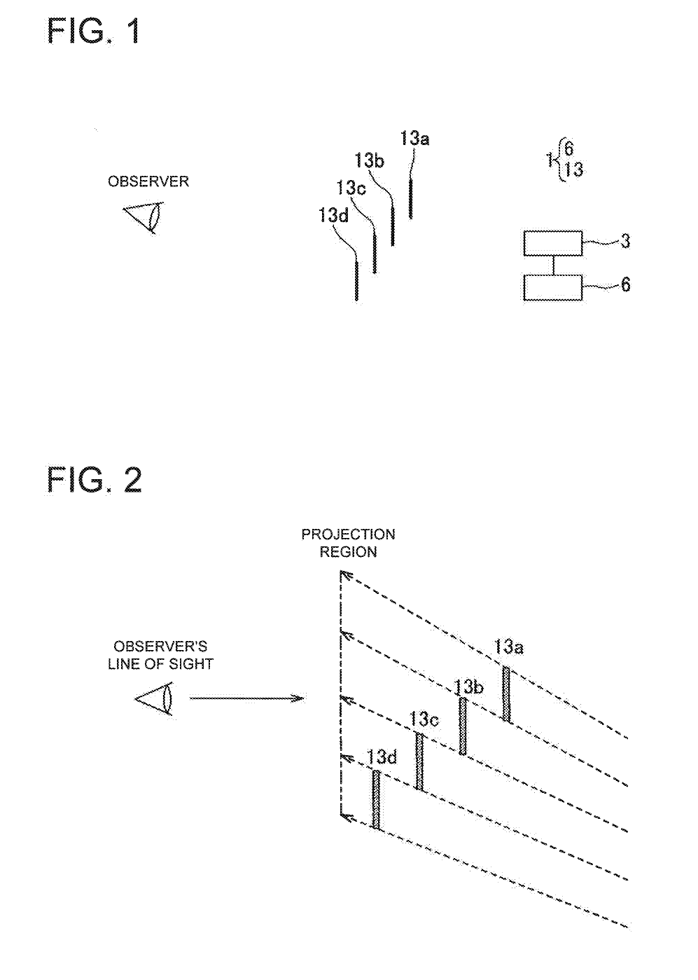

A display device 1 according to a first embodiment of the present invention will be described with reference to FIGS. 1 to 5. As shown in FIG. 1, for example, the display device 1 is a device configured to display projection light from a projector 3 and includes a video controller 6 and a screen 13.

With an LED (light-emitting diode) or a laser, for example, used as a light source, the projector 3 projects video to be displayed onto the screen 13 of the display device 1 via a mirror 4.

The video controller 6, which serves as a control unit, subjects externally inputted video (image) or internally stored video, for example, to processing to be described later, and then outputs the processed video (image) to the projector 3.

The screen 13, which serves as a display unit, includes four screens 13a, 13b, 13c, and 13d. The screen 13a comprises a transparent screen such as a microlens array or a light scattering sheet, for example. The screen 13a is formed in a rectangular shape. While the screens 13a, 13b, 13c, and 13d have a strip shape in the present embodiment, these screens may have other rectangular shapes such as a square. Alternatively, the screen 13 may be a self-luminous display requiring no projector 3 (such as an EL (electro-luminescence) display).

Video display with the display device 1 having the above-described configuration will be described next with reference to FIGS. 2 to 5. FIG. 2 is an explanatory diagram for the display of video projected onto the screen 13. FIG. 2 is shown in a simplified manner by illustrating only the screens 13a, 13b, 13c, and 13d. As shown in FIG. 2, the video is projected onto the screens 13a, 13b, 13c, and 13d by the projector 3, which serves as a projection unit. The display device 1 in this case is arranged in such a manner that a light ray of the projection light always strikes (overlaps with) one or more screens in order to prevent the leakage of the projection light from between the screens 13a, 13b, 13c, and 13d.

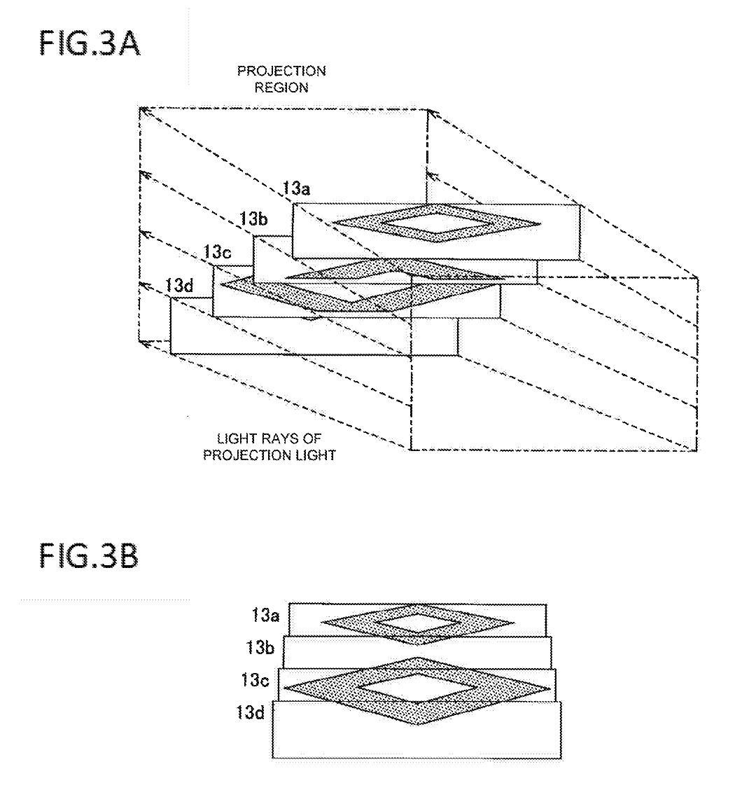

FIG. 3 shows how the projection light projected onto the screen 13 is seen by an observer. FIG. 3(a) shows a displayed state of the screen as seen from a side where the projection light is projected. FIG. 3(b) shows how the state of FIG. 3(a) is seen by the observer. In FIG. 3, video outputted from the video controller 6 is projected onto the screens 13a, 13b, 13c, and 13d as projection light by the projector 3.

When the projection light is projected onto the screens 13a, 13b, 13c, and 13d as shown in FIG. 3(a), the resultant display is seen as in FIG. 3(b) by the observer shown in FIG. 2, i.e., display of a greater depth (depth display) is obtained.

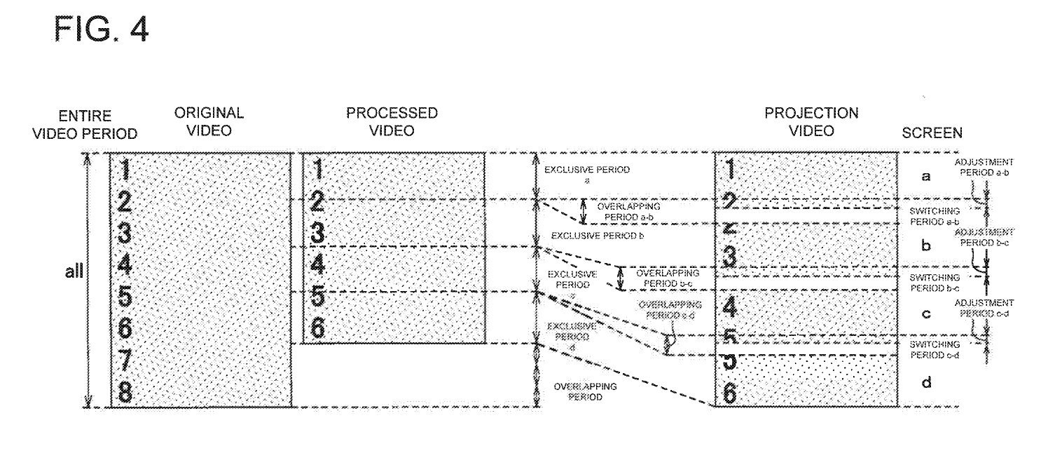

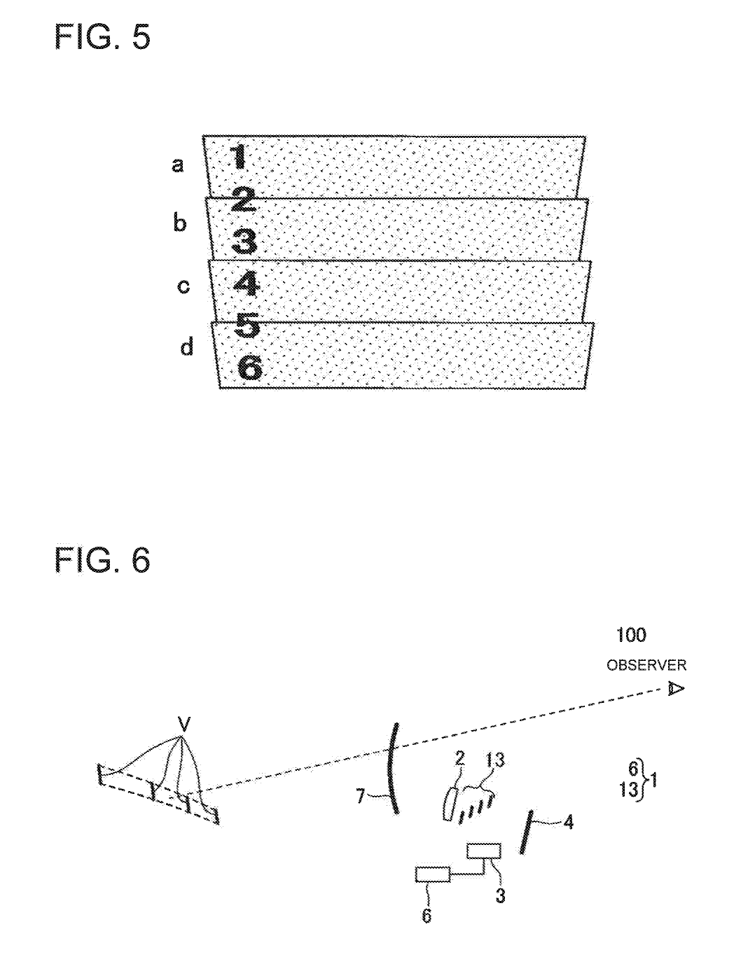

Video displayed on the respective screens 13a, 13b, 13c, and 13d will be described next. Since the respective screens 13a, 13b, 13c, and 13d are arranged so as to prevent the leakage of the projection light from the projector, for example, as mentioned above, ends of the respective screens 13a, 13b, 13c, and 13d in a transverse direction overlap with one another as seen from the observer. Thus, when the video to be displayed on the respective screens 13a, 13b, 13c, and 13d is divided simply by the number of the screens, the video appears to be partially missing along boundaries between the screens. In view of this, the video controller 6 in the present embodiment processes original video, and then the processed video is displayed. A method of the processing will be described with reference to FIGS. 4 and 5.

Original video in FIG. 4 is video before being subjected to the processing. A termination part of an entire video period is deleted from the original video to obtain processed video as shown. In the processed video, a video period during which display on each screen is performed is referred to as an exclusive period, and a period corresponding to the part deleted from the original video is referred to as an overlapping period.

In projection video (video outputted to the projector, for example), the overlapping period is a period inserted between the exclusive periods, which are the video periods during which display on the screens is performed. Of the overlapping period, a period during which a light ray of the projection light strikes a screen disposed on the far side as seen from the observer and thus the observer cannot visually recognize such light ray is defined as a switching period. In the switching period, the video is turned OFF or processing such as inserting a black image is performed. The remaining period obtained by subtracting the switching period from the overlapping period corresponds to an adjustment period for displacement in the line of sight.

In this adjustment period, the same video as the beginning part of the exclusive period following such an adjustment period is displayed. For example, video corresponding to an exclusive period a and an adjustment period a-b is projected onto the screen for displaying the top part of the video in FIG. 4. More specifically, in the example of FIG. 4, a region of the screen 13a where an image corresponding to an adjustment period is displayed corresponds to a first region that is a part of one display unit, and a region of the screen 13b where the same image as the image corresponding to the adjustment period is displayed corresponds to a second region that is a part of another display unit. Thus, the video displayed in these regions corresponds to partial images displayed in the first region and the second region. In other words, a lower end of the screen 13a where the part corresponding to this adjustment period is displayed serves as the first region, and a part of an upper end of the screen 13b where the same display content as the part displayed during the adjustment period is displayed serves as the second region. Consequently, as shown in FIG. 5, video as seen from the observer has no missing part, thus achieving continuous display.

While the partial images in the first region and the second region have the same content in the above description, the partial images may not be exactly identical with each other. The partial images may have different luminance levels or resolutions, or an image obtained by correcting one of the images may be used. In other words, those images may differ from each other as far as continuous video can be obtained and the observer can visually recognize the video. That is, it is only necessary that an image based on the partial image displayed in the first region is displayed in the second region.

According to the present embodiment, there are included the screens 13a, 13b, 13c, and 13d that perform display at positions having different distances from the observer, and the video controller 6 that causes the screens 13a, 13b, 13c, and 13d to display images, respectively. The screens 13a, 13b, 13c, and 13d perform display in such a manner that the lower end of the screen 13a and the upper end of the screen 13b, from among the screens 13a, 13b, 13c, and 13d, overlap with each other as seen from the observer. The video controller 6 causes the upper end of the screen 13a and the lower end of the screen 13b to display the same partial image. In this manner, the ends of the screens 13a and 13b, for example, are arranged in an overlapping manner, thus making it possible to reduce light leakage, for example, as much as possible. In the overlapping portion between the screen 13a and the screen 13b, the same content is displayed also on the screen 13b disposed on the near side thereof. Thus, partial image missing in the overlapping portion can be prevented from occurring.

### Second Embodiment

A display device according to a second embodiment of the present invention will be described next with reference to FIG. 6. Note that the same portions as those described above in the first embodiment will be denoted by the same reference numerals and the description thereof will be omitted.

The present embodiment shows an example in which the above-described display device 1 is applied to a head-up display. As shown in FIG. 6, a head-up display 100, which includes a display device 1, a field lens 2, a projector 3, a mirror 4, and a combiner 7, is installed in a vehicle such as an automobile.

The field lens 2 collects emitted light from the display device 1 toward the combiner 7.

The mirror 4 reflects projection light projected by the projector 3 toward the display device 1.

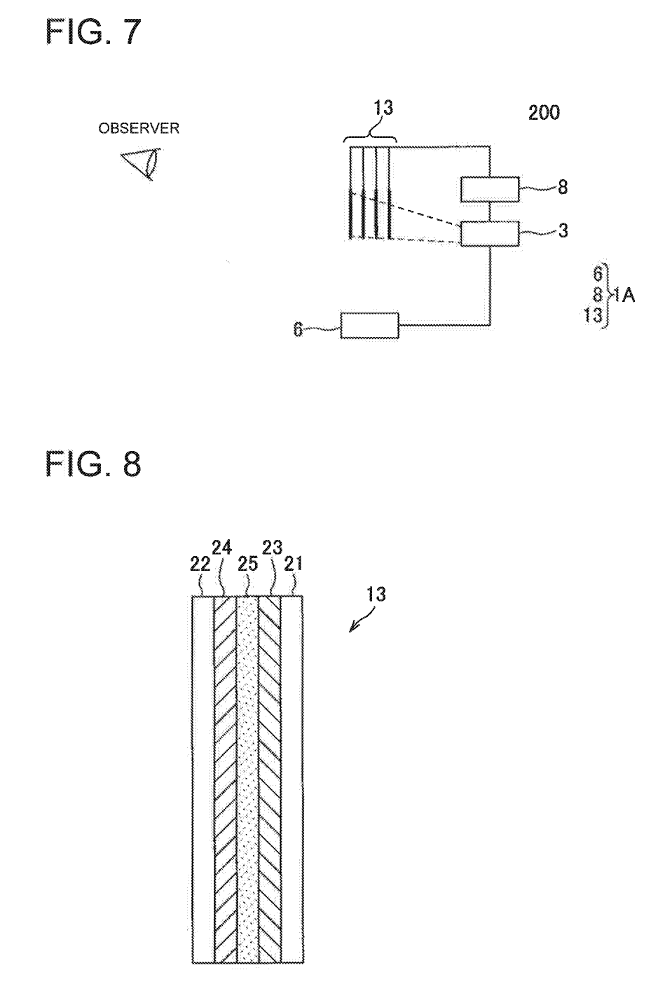

A video controller 6 according to the present embodiment generates, or externally obtains, video to be displayed as a virtual image. The video controller 6 then subjects the video to processing having been described with reference to FIG. 7, for example, and outputs the processed video to the projector 3.

The combiner 7 is provided to a front window (also referred to as a windshield) of an automobile, for example, to reflect emitted light (video light) from the field lens 2 toward an observer.

In the above-described head-up display 100, the video outputted from the video controller 6 is projected by the projector 3 as video light, reflected by the mirror 4, and projected onto a screen 13 of the display device 1. The video projected onto the screen 13 is reflected by the combiner 7 toward the observer via the field lens 2. In this manner, the video is visually recognized as a virtual image V by the observer with the combiner 7 (front window) interposed therebetween.

Also in this virtual image V, a plurality of virtual images are displayed at different positions from the observer. A region of the virtual image corresponding to the first region and a region of the virtual image corresponding to the second region are displayed in an overlapping manner as seen from the observer.

Since the display device 1 is employed in the head-up display 100 in the present embodiment, continuous display of the virtual image V visually recognized by the observer in the head-up display 100 can be achieved.

### Third Embodiment

A display device according to a third embodiment of the present invention will be described next with reference to FIGS. 7 to 10. Note that the same portions as those described above in the first and second embodiments will be denoted by the same reference numerals and the description thereof will be omitted.

The basic configuration in the present embodiment is the same as that of the display device 1 shown in the first embodiment. The size of a screen 13 (13f, 13g, 13h, and 13i) and elements thereof, however, differ from those of the display device 1 in the first embodiment.

The general configuration of a display device 1A according to the present embodiment will be shown in FIG. 7. As with the first embodiment, the display device 1 is a device for displaying projection light from a projector 3 and includes a video controller 6, a screen driving device 8, and the screen 13.

The screen 13 of the present embodiment has the same height and has a length approximately corresponding to the total of the lengths of the screens 13a, 13b, 13c, and 13d of the first embodiment in the height direction. In other words, the screens 13f, 13g, 13h, and 13i are arranged in such a manner that approximately the entire surfaces thereof overlap with one another.

A screen in which an optical state thereof changes by the application of voltage is employed as the screen 13 of the present embodiment. With regard to the optical states of the screen 13, a scattering state corresponds to a video state, and a transparent transmission state having less scattering of incident light and a higher transmittance of parallel rays than those in the scattering state corresponds to a non-video state. That is, the transmission state and the scattering state can be switched therebetween for light.

The screen 13 may be, for example, a dimmable screen that employs a liquid crystal material to change the scattering state and the transparent transmission state having less scattering of incident light. Examples of such a dimmable screen may include dimmable screens that employ a liquid crystal element such as a polymer dispersed liquid crystal.

FIG. 8 is a schematic cross-sectional view of the screen 13 capable of controlling its optical state. The screen 13 shown in FIG. 8 has, between a pair of transparent glass plates 21 and 22, an optical layer 25 in which a composite material including a liquid crystal, for example, is interposed. A common electrode 23 is formed on a surface of one glass plate 21 closer to the optical layer 25. A scanning electrode 24 is formed on a surface of the other glass plate 22 closer to the optical layer 25. Note that intermediate layers made of an insulating material may be formed between the electrodes 23 and 24 and the optical layer 25.

With the use of ITO (indium tin oxide), for example, the common electrode 23 and the scanning electrode 24 are formed as transparent electrodes. The optical layer 25 is disposed between the common electrode 23 and the scanning electrode 24.

Voltage is applied to the screen 13 so as to create a potential difference between the scanning electrode 24, which serves as a first electrode, and the common electrode 23, which serves as a second electrode. An optical state in the optical layer 25 changes in accordance with the applied voltage of the common electrode 23 and the scanning electrode 24.

The screen 13 is classified into a reverse mode and a normal mode depending on a state when voltage is applied so as to create a potential difference. For the screen 13 operating in the reverse mode, the screen 13 is in the transparent transmission state under a normal state without the application of voltage. When voltage is applied, the screen 13 is in the scattering state having a scattering rate of parallel rays depending on the applied voltage. For the screen operating in the normal mode, the screen 1 is in the scattering state under the normal state without the application of voltage. When voltage is applied, the screen 13 is in the transparent transmission state having a transmittance of parallel rays depending on the applied voltage. With regard to the optical states of the screen 13, the predetermined scattering state corresponds to the video state, and the transparent transmission state having a higher transmittance of parallel rays than that in the predetermined scattering state corresponds to the non-video state. Note that the following description pertains to the reverse mode but can be applied also to the normal mode.

As with the first embodiment, the video controller 6 subjects externally inputted video or internally stored video, for example, to the above-described processing, and then outputs the processed video to the projector 3.

To perform driving to be described later, the screen driving device 8 performs the control of the transmission state and the scattering state of the screens 13f, 13g, 13h, and 13i and the control of projection timing of the projector 3, for example.

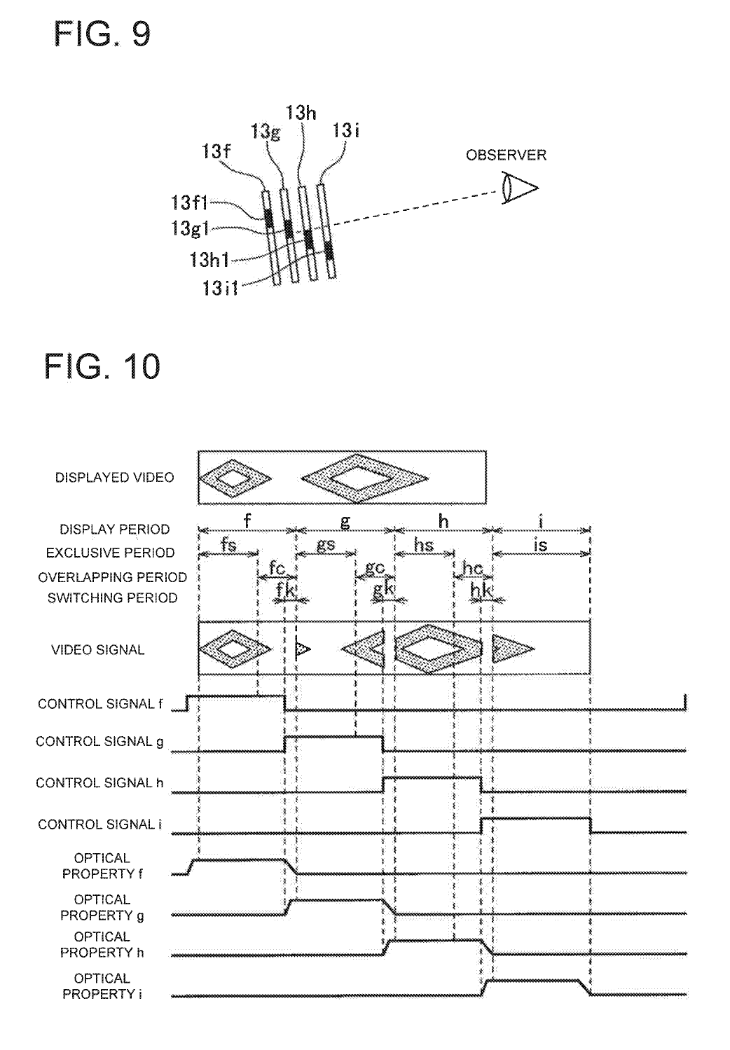

Operations of the above-described screen 13 will be described next with reference to a timing chart of FIG. 10. In FIG. 10, the screens 13i, 13h, 13g, and 13f are arranged in this order from the observer side as shown in FIG. 9. Displayed video in FIG. 10 is the same as that in FIG. 3. An image corresponding to the screen 13a of FIG. 3 is displayed in a region 13f1 of the screen 13f, and an image corresponding to the screen 13b of FIG. 3 is displayed in a region 13g1 of the screen 13g. An image corresponding to the screen 13c of FIG. 3 is displayed in a region 13h1 of the screen 13h, and an image corresponding to the screen 13d of FIG. 3 is displayed in a region 13i1 of the screen 13i. That is, the screens 13f, 13g, 13h, and 13i are provided with electrodes so that only such regions can be set to the scattering state.

With regard to display periods in FIG. 10, “f” denotes a display period of the screen 13f, “g” denotes a display period of the screen 13g, “h” denotes a display period of the screen 13h, and “i” denotes a display period of the screen 13i. Of the display periods, exclusive periods fs, gs, hs, and is, overlapping periods fc, gc, and hc, and switching periods fk, gk, and hk correspond to the exclusive period, the overlapping period, and the switching period described in the first embodiment.

For a video signal, the displayed video is separated into the display periods. A control signal f is a switching signal (Hi causes the scattering state) between the transmission state and the scattering state for the screen 13f, which is outputted by the screen driving device 8. Similarly, a control signal g is a switching signal between the transmission state and the scattering state for the screen 13g, which is outputted by the screen driving device 8. A control signal h is a switching signal between the transmission state and the scattering state for the screen 13h, which is outputted by the screen driving device 8. A control signal i is a switching signal between the transmission state and the scattering state for the screen 13i, which is outputted by the screen driving device 8.

An optical property f is the optical property of the screen 13f (Hi corresponds to the scattering state). Similarly, an optical property g is the optical property of the screen 13g, an optical property h is the optical property of the screen 13h, and an optical property i is the optical property of the screen 13i.

As shown in FIG. 10, the screen driving device 8 generates the control signals f, g, h, and i so that a transient period (rise and fall periods of optical properties) during which the screen 13 is switched corresponds to a switching period in the present embodiment. For example, the fall timing of the control signal f and the rise timing of the control signal g are controlled by the screen driving device 8 so that the fall period of the optical property f and the rise period of the optical property g correspond to the period of the switching period fk. In other words, the screen driving device 8 (control unit) controls the switching period from the scattering state to the transmission state in the screen 13f (one display unit) and the switching period from the transmission state to the scattering state in the screen 13g (another display unit) to be the display period of an image corresponding to a part of a partial image that cannot be visually recognized by the observer (switching period fk).

According to the present embodiment, the switching period fk, which is the display period of the image corresponding to the part of the partial image displayed during the overlapping period fj that cannot be visually recognized by the observer, is set to be the switching period from the transmission state to the scattering state, for example. This allows for display switching to another screen in the part that cannot be visually recognized by the observer due to the overlapping of the screens. Thus, light leakage, for example, can be reduced at the time of switching.

In the screens 13f, 13g, 13h, and 13i capable of switching between the transmission state and the scattering state, depth display is achieved by causing the period of the scattering state to transition from one screen to another sequentially. In this manner, a region to be in the scattering state can be set as desired by the division of an electrode.

While the above-described switching period from the scattering state to the transmission state and switching period from the transmission state to the scattering state preferably correspond to the above-described switching period fk, for example, it is only necessary that such switching periods occur within the overlapping period. Since the overlapping period always contains a period during which the same video (partial image) is displayed, influence on display at the time of switching can be diminished.

While the scattering state transitions in the order of the screens 13f, 13g, 13h, and 13i in the above description, the scattering state may conversely transition in the order of the screens 13i, 13h, 13g, and 13f. Also, in such a case, influence on display at the time of switching can be diminished in a similar manner to the above. In other words, it is only necessary that the switching period between the scattering state and the transmission state in one display unit and the switching period between the transmission state and the scattering state in another display unit are controlled to be a period during which a partial image is displayed.

### Fourth Embodiment

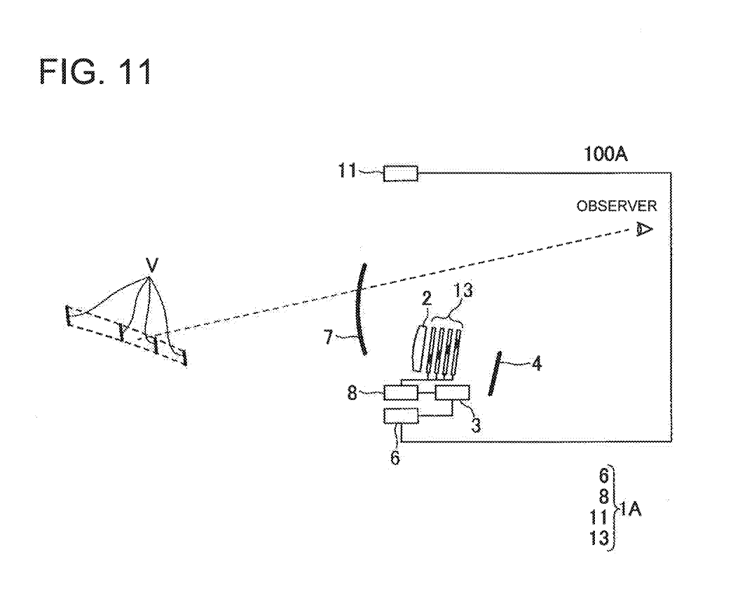

A display device according to a fourth embodiment of the present invention will be described next with reference to FIGS. 11 to 20. Note that the same portions as those described above in the first to third embodiments will be denoted by the same reference numerals and the description thereof will be omitted.

The present embodiment shows an application example of the display device 1A including the configuration described in the third embodiment.

FIG. 11 shows a head-up display 100A further including an eye-gaze detector 11 in addition to the display device 1A in the head-up display 100 shown in FIG. 6. The eye-gaze detector 11, which serves as an eye-gaze detection unit, comprises a camera, for example. The eye-gaze detector 11 detects the line of sight of an observer by a well-known method on the basis of a positional relationship between the inner corner of an eye of the observer and its iris, for example. Note that a method of eye-gaze detection is not limited to the above-described method but may be any other method.

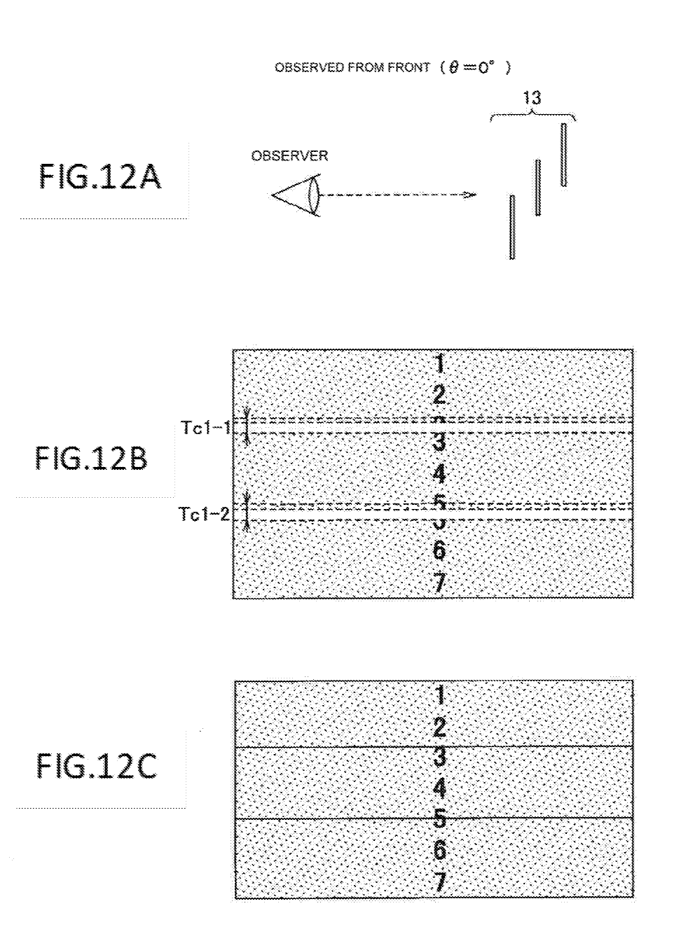

On the basis of a result of the eye-gaze detection by the eye-gaze detector 11, the video controller 6 adjusts overlapping periods in video to be outputted to the projector 3. A method of such an adjustment will be described with reference to FIGS. 12 to 14. FIG. 12 shows a case where the screen 13, which is arranged as shown in FIG. 12(a), is observed from the front (θ=0°). In this case, overlapping periods Tc1-1 and Tc1-2 as shown in FIG. 12(b) are set. Such an image is seen as in FIG. 12(c) by the observer.

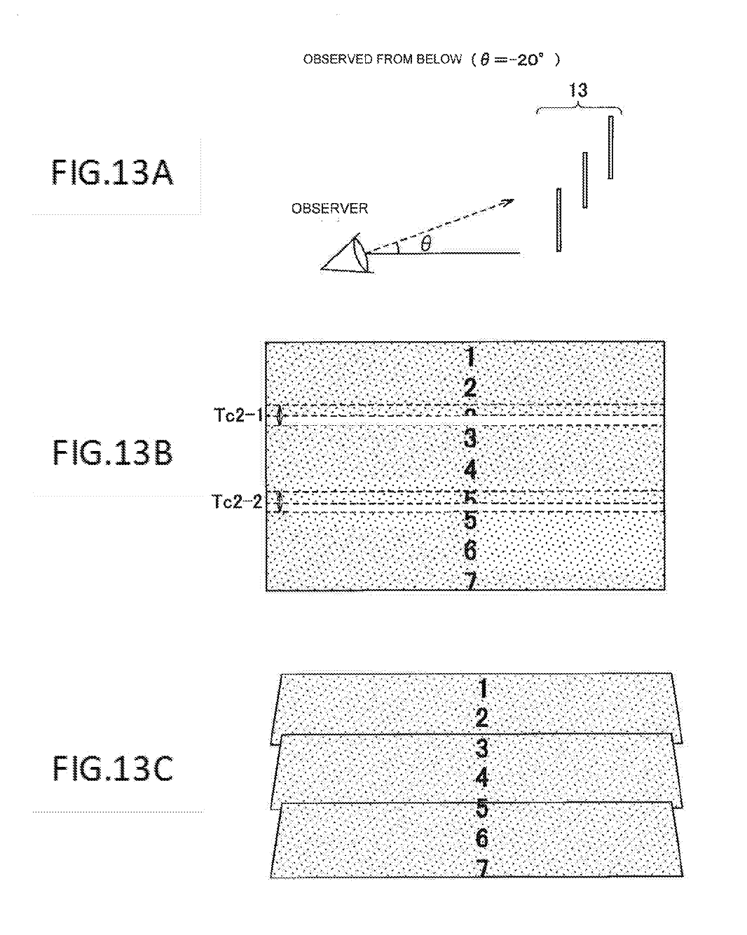

Next, FIG. 13 shows a case where the screen 13 having the same arrangement as that in FIG. 12(a) is observed from below (θ=−20°). In this case, overlapping periods Tc2-1 and Tc2-2 as shown in FIG. 13(b) are set. The periods Tc2-1 and Tc2-2 are longer than the periods Tc1-1 and Tc1-2. This is because a region of the screen 13 seen as overlapping becomes larger when the screen 13 is observed from below as in FIG. 13(a). Such an image is seen as in FIG. 13(c) by the observer. In other words, when it is detected that the screen 13 is being observed from below, the first region (overlapping region) is set to be larger than when the screen 13 is observed from the front. Because of the increased first region, the second region in which the same partial image is displayed becomes larger accordingly.

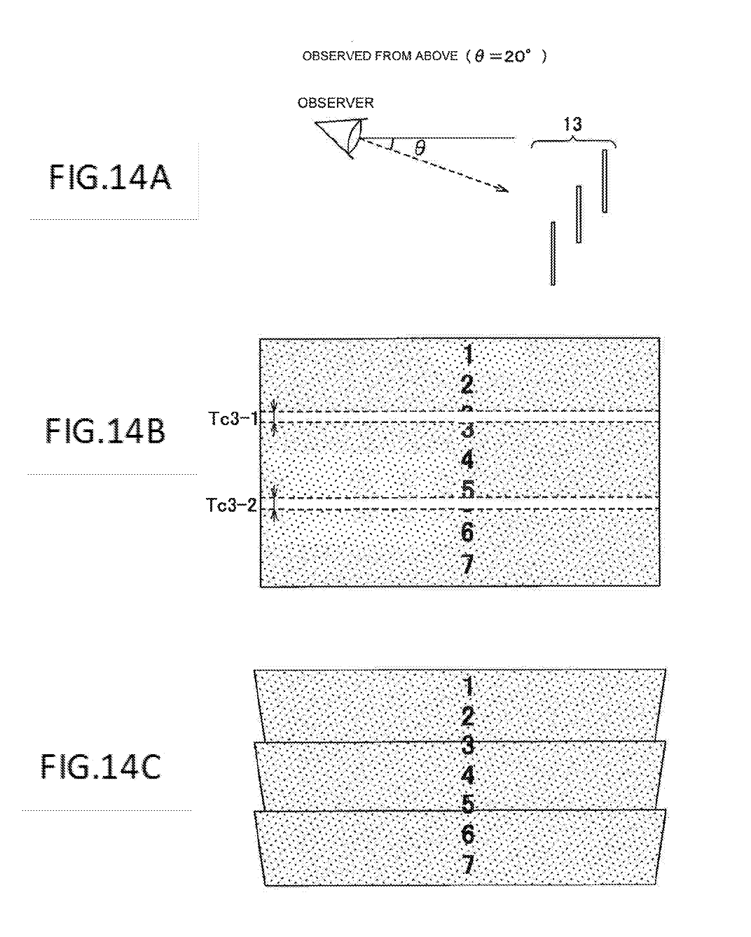

Next, FIG. 14 shows a case where the screen 13 having the same arrangement as that in FIG. 12(a) is observed from above (θ=20°). In this case, overlapping periods Tc3-1 and Tc3-2 as shown in FIG. 14(b) are set. The periods Tc3-1 and Tc3-2 are shorter than the periods Tc1-1 and Tc1-2. This is because a region of the screen 13 seen as overlapping becomes smaller than when the screen 13 is observed from above as in FIG. 14(a). Such an image is seen as in FIG. 14(c) by the observer. In other words, when it is detected that the screen 13 is being observed from above, the first region (overlapping region) is set to be smaller than when the screen 13 is observed from the front. Because of the reduced first region, the second region in which the same partial image is displayed becomes smaller accordingly.

In the configuration of FIG. 11, a reference position corresponding to the front, for example, is predetermined. Whether the screen is being observed from below or observed from above with respect to that position is determined on the basis of a detection result of the eye-gaze detector 11. On the basis of the detection result (angle), the video controller 6 adjusts the overlapping periods.

In FIGS. 11 to 14, the eye-gaze detector 11 configured to detect the line of sight of an observer is further included and the video controller 6 changes the ranges of the first region and the second region on the basis of the detection result of the eye-gaze detector 11. In this manner, the ranges of the first region and the second region can be adjusted according to the position of the observer to achieve continuous display.

Note that the method of FIGS. 11 to 14 can also be applied to the configurations described in the first and second embodiments.

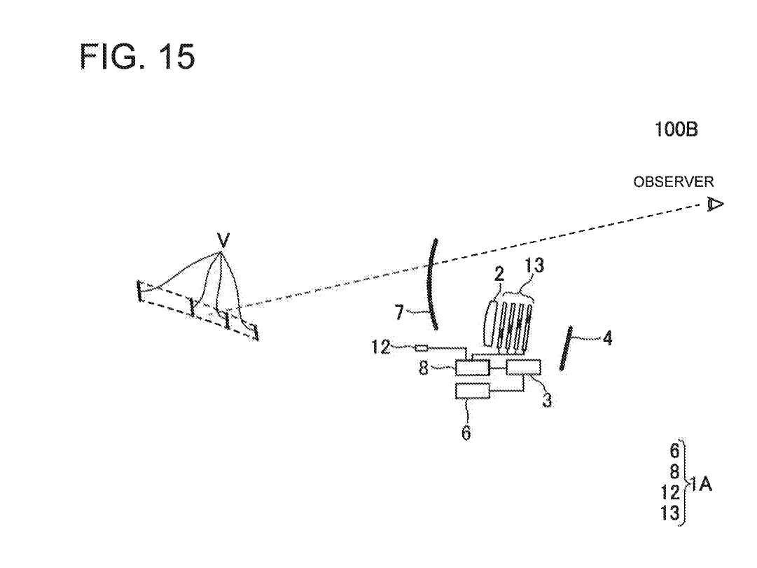

FIG. 15 shows a head-up display 100B further including a temperature sensor 12 in addition to the display device 1A in the head-up display 100 shown in FIG. 6. The temperature sensor 12, which serves as a temperature detection unit, is disposed in the vicinity of the screen 13 and detects a temperature in the vicinity of the screen 13. Note that the temperature sensor 12 used may be a well-known sensor element such as a thermistor.

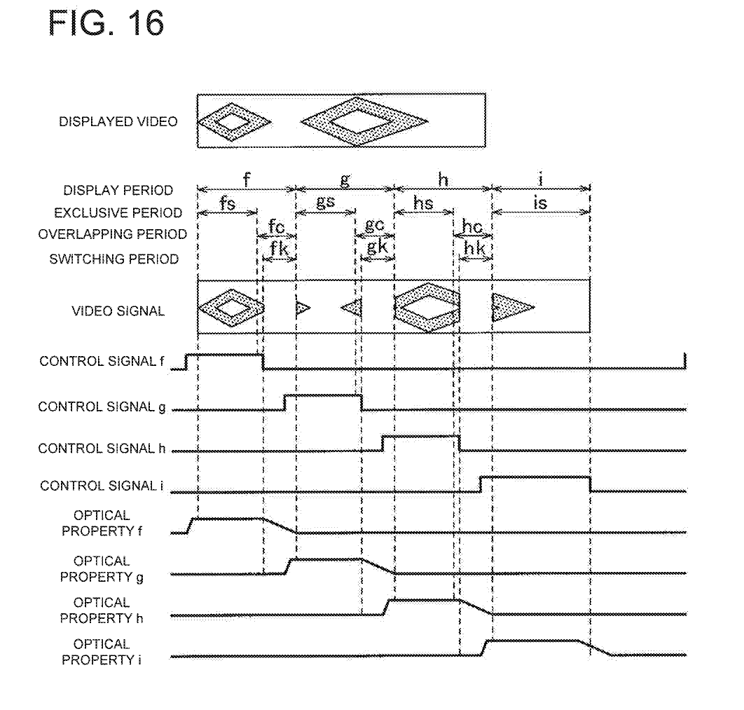

In the configuration of FIG. 15, the switching periods of the screen 13 are changed on the basis of a detection result of the temperature sensor 12. A timing chart is shown in FIG. 16. Respective waveforms in FIG. 16 show the same items as those in FIG. 10. In the screen 13 shown in FIG. 8, switching time to the scattering state and the transmission state varies according to temperature. In view of this, when transient response periods (transient periods) of the optical properties become slow, the switching periods fk, gk, and hk are prolonged on the basis of an ambient temperature of the screen 13 detected by the temperature sensor 12 in FIG. 16. Thus, even when the temperature effect causes a gradual fall as in the optical properties f, g, h, and i in FIG. 16, such a period is set as a switching period, thus reducing influence on video display.

According to FIGS. 15 and 16, the temperature sensor 12 configured to detect an ambient temperature of the screen 13 is further included, and the video controller 6 changes the ranges of the first region and the second region on the basis of the detection result of the temperature sensor 12. In this manner, it is possible to cope with change in switching period, for example, to the scattering state due to temperature. Thus, even when the ambient temperature of the screen 13 varies, partial video missing or light leakage, for example, can be prevented from occurring.

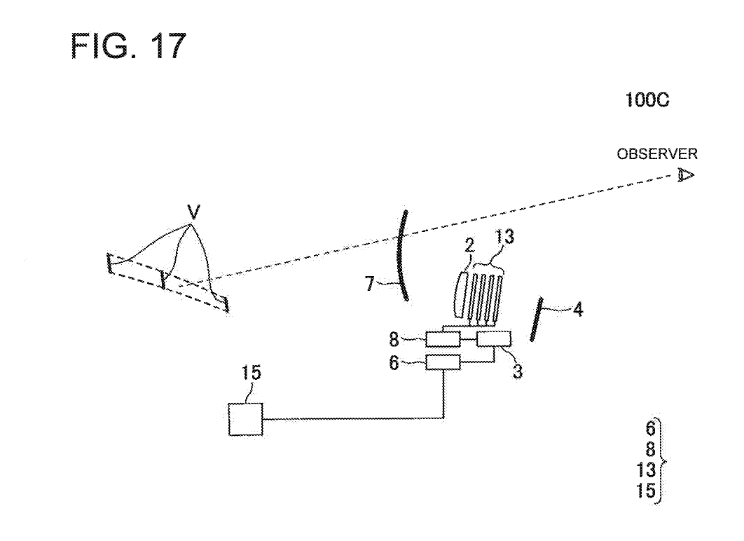

FIG. 17 shows a head-up display 100C further including a proximity sensor 15 in addition to the display device 1A in the head-up display 100 shown in FIG. 6. The proximity sensor 15 is disposed at a front end or a rear end of a vehicle where the head-up display 100C is installed, for example. The proximity sensor 15 may be any well-known type of sensor capable of detecting a pedestrian, for example, by means of ultrasonic waves or infrared rays, for example.

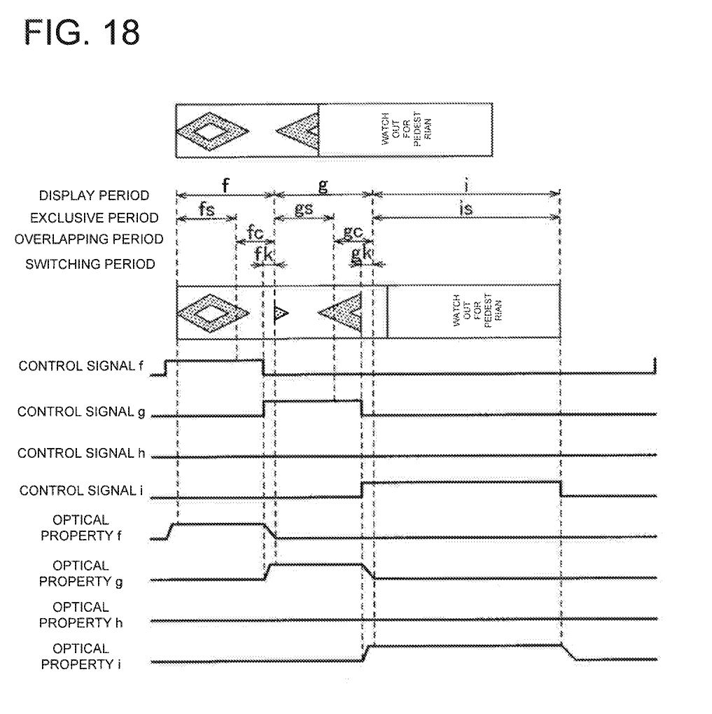

In the configuration of FIG. 17, display on the screen 13 is changed on the basis of a detection result of the proximity sensor 15. A timing chart is shown in FIG. 18. Waveforms in FIG. 18 have the same items as those in FIG. 10. In FIG. 18, once the proximity sensor 15 detects a pedestrian, for example, display on the screen 13h is ceased and a planar image (“Watch out for pedestrian”) having a size equal to the display regions of the screen 13i and the screen 13h is displayed on the screen 13i. The screens 13f and 13g perform depth display as with FIG. 10, for example. In other words, there are included three or more screens (display units), and the video controller 6 and the screen driving device 8 control the screens 13f and 13g (at least two adjacent display units) of the screens 13f, 13g, 13h, and 13i (a plurality of display units) so as to display the same partial image in the first region and the second region and control the first region and the second region of the screen 13i (the remaining display unit) so as not to display the same partial image.

According to FIGS. 17 and 18, of the screens 13f, 13g, 13h, and 13i, the same partial image is displayed in the first region of the screen 13f and the second region of the screen 13g, whereas a planar image different from the screens 13f and 13g is displayed on the screen 13i. In other words, an image based on the partial image displayed in the first region of the screen 13f is displayed in the second region of the screen 13g, whereas no image based on the partial image displayed in the first region of the adjacent screen disposed on the far side is displayed on the remaining screen. Thus, display such that the depth display and the planar display are mixed can be obtained.

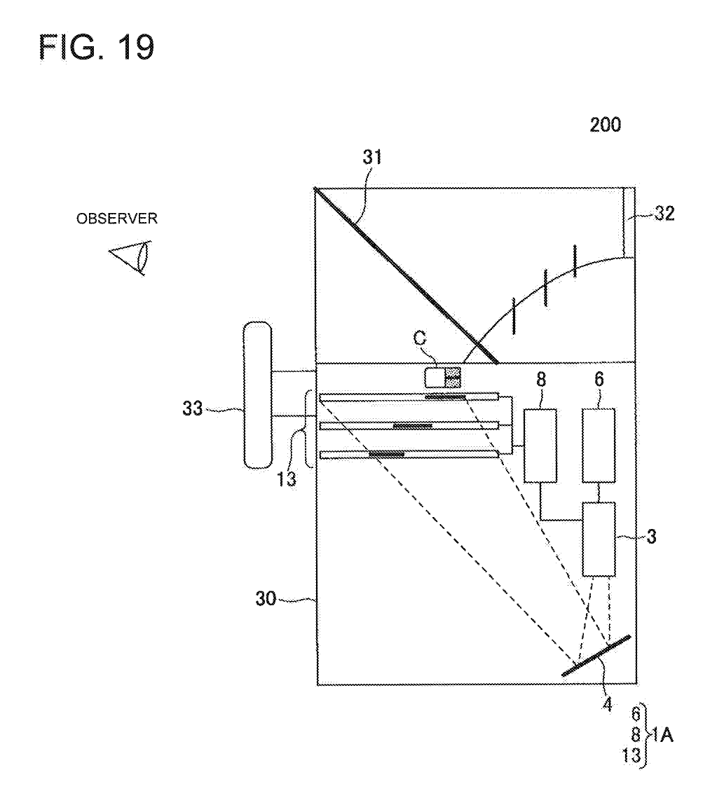

FIG. 19 shows an example in which the display device 1A is applied to an amusement machine. An amusement machine 200 accommodates the display device 1A, the projector 3, the mirror 4, a half mirror 31, and a display 32 in a housing 30. A handle 33 is attached to the housing 30 to implement a driving game for driving a model car C.

As with the other embodiments, the projector 3 emits image information outputted from the video controller 6 to the mirror 4 as projection light. The mirror 4 reflects the projection light projected by the projector 3 toward the display device 1.

The half mirror 31 transmits light from the display 32 therethrough and reflects light from the screen 13 toward an observer. The display 32 comprises a display device such as a liquid crystal display or an EL display.

Note that the configuration shown in FIG. 11, the configuration shown in FIG. 15, and the configuration shown in FIG. 17 may be combined with one another.

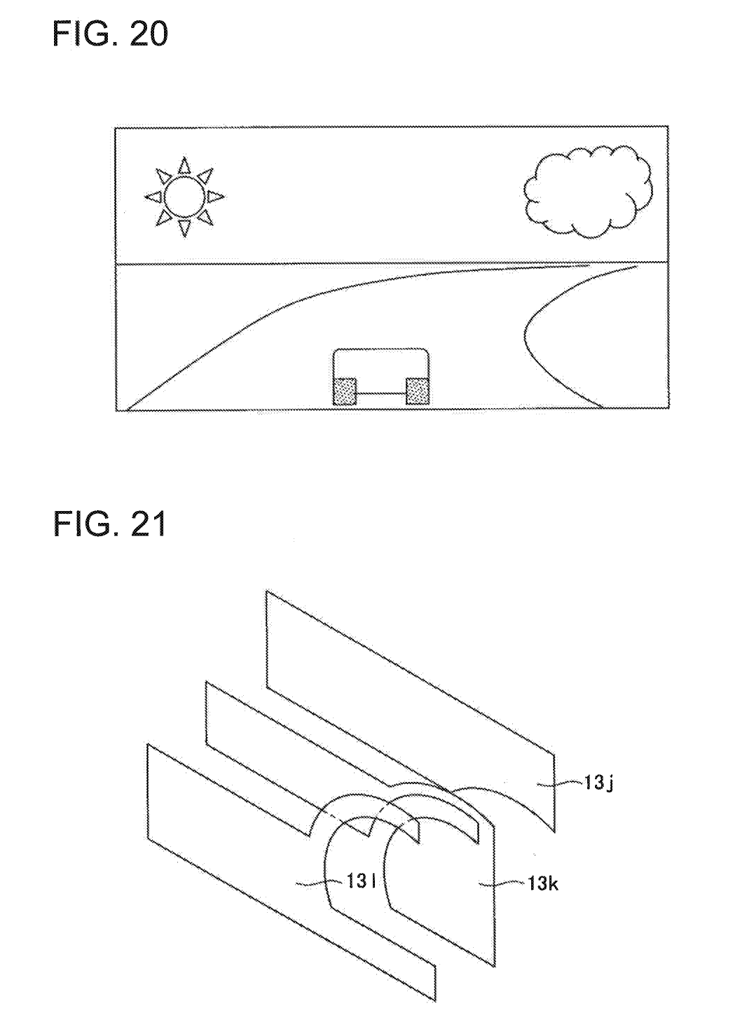

In the amusement machine 200 having the above-described configuration, a background is displayed on the display 22 and depth display is achieved by the display device 1 in a road region on which the model car C runs, as shown in FIG. 20.

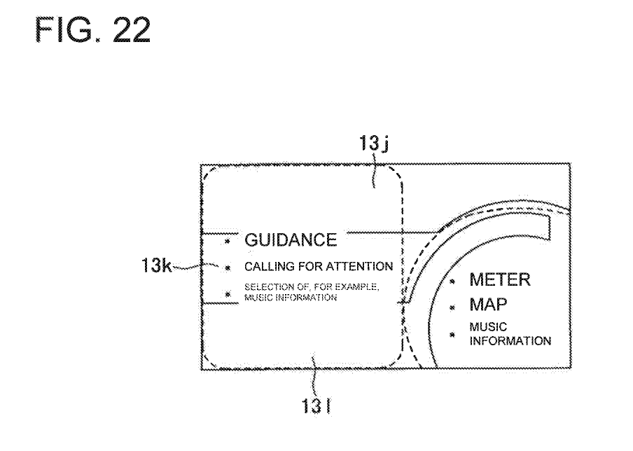

Note that the shape of the screen is not limited to a rectangle but may be free-form as shown in FIGS. 21 and 22. Screens 13j, 13k, and 13l shown in FIG. 21 have shapes other than rectangles as illustrated. When the screens shown in FIG. 21 are employed in a head-up display of a vehicle, for example, a meter, for example, may be displayed on the right and a variety of information such as guidance information or calling for attention may be displayed on the left as shown in FIG. 22.

The present invention is not limited to the above embodiments. That is, the present invention can be implemented while making various modifications thereto by those skilled in the art on the basis of conventionally-known knowledge without departing from the gist of the present invention. It is to be noted that such modifications are still included in the range of the present invention as long as the configuration of the display device of the present invention is included.

### REFERENCE SIGNS LIST

1, 1A display device

6 video controller (control unit)

8 screen driving device (control unit)

11 eye-gaze detector (eye-gaze detection unit)

12 temperature sensor (temperature detection unit)

15 proximity sensor

13a screen (display unit)

13b screen (display unit)

13c screen (display unit)

13d screen (display unit)

13e screen (display unit)

13f screen (display unit)

13g screen (display unit)

13h screen (display unit)

13i screen (display unit)

13j screen (display unit)

13k screen (display unit)

13l screen (display unit)

1. A display device comprising:
a plurality of display units configured to perform display and arranged at positions having respectively different distances from an observer; and
one or more processors configured to cause said plurality of display units to display images, respectively, wherein
said plurality of display units are arranged in such a manner that at least a first region that is a part of one display unit of said plurality of display units and a second region that is a part of another display unit disposed adjacent to said one display unit and closer to the observer overlap with each other as seen from the observer, and
said one or processors causes said second region to display an image based on a partial image displayed in said first region.

2. The display device according to claim 1, wherein
said plurality of display units can be switched between a transmission state in which light is transmitted and a scattering state in which said light is scattered, and
said one or more processors controls a switching period between said scattering state and said transmission state in said one display unit and a switching period between said transmission state and said scattering state in said another display unit to be a period during which said partial image is displayed.

3. The display device according to claim 2, wherein said one or more processors sets a display period of an image corresponding to a part of the partial image displayed in said first region that cannot be visually recognized by the observer to be the switching period between said scattering state and said transmission state.

4. The display device according to claim 2, further comprising a temperature detection unit configured to detect an ambient temperature of said display units, wherein
said one or more processors changes ranges of said first region and said second region on a basis of a detection result of said temperature detection unit.

5. The display device according to claim 1, further comprising an eye-gaze detection unit that detects a line of sight of said observer, wherein
said one or more processors changes ranges of said first region and said second region on a basis of a detection result of said eye-gaze detection unit.

6. The display device according to claim 1, wherein said display units comprise three or more display units, and
said one or more processors controls at least two adjacent display units of said plurality of display units so as to display the image based on the partial image displayed in said first region in said second region and controls a remaining display unit so as not to display the image based on the partial image displayed in said first region.

7. A display method of a display device including a plurality of display units configured to perform display and arranged at positions having respectively different distances from an observer, said plurality of display units being arranged in such a manner that at least a first region that is a part of one display unit of said plurality of display units and a second region that is a part of another display unit disposed adjacent to said one display unit and closer to the observer overlap with each other as seen from the observer, the method comprising:
a control step of causing the plurality of display units to display images, respectively, wherein
said control step includes causing said second region to display an image based on a partial image displayed in said first region.

8. A display program configured to cause a computer to execute the display method according to claim 7.

9. A computer-readable recording medium that stores the display program according to claim 8.

10. A display device comprising:
a plurality of display units configured to perform display and arranged at positions having respectively different distances from an observer; and
one or more processors configured to cause said plurality of display units to display images, respectively, wherein
said one or more processors controls said plurality of display units to display images in such a manner that at least an image displayed in a first region that is a part of one display unit of said plurality of display units and an image displayed in a second region that is a part of another display unit closer to the observer than said one display unit overlap with each other as seen from the observer.
